(19) United States
(12) Patent Application Publication
(10) Pub. No.: US 2012/0226486 A1
(43) Pub. Date: Sep. 6, 2012

(54) TRAINING SIMULATOR AND RELATED METHODS

(76) Inventor: Ken M. Plocek, Lincoln, TX (US)

(21) Appl. No.: 13/409,921

(22) Filed: Mar. 1, 2012

Related U.S. Application Data
(60) Provisional application No. 61/449,383, filed on Mar. 4, 2011.

(51) Int. Cl. G06G 7/48

(52) U.S. Cl. 703/7

(57) ABSTRACT

An engine simulator is utilized for training purposes. The simulator comprises a fully functioning control system and pressure modules, pumps and variable drive motors to simulate a engine faults. A programmable logic controller and other related components simulate engine activities and operational sequences that interface with controls system. A trainer is able to “bug” the system physically, electronically or via programming, thus allowing applied on the job training during the course of instruction without any service interruption to real equipment.

### PRIORITY

This application is a non-provisional of and claims priority to U.S. Provisional Application No. 61/449,383 entitled, “TRAINING SIMULATOR AND METHOD,” filed Mar. 4, 2011, also naming Ken M. Plocek as sole inventor, the disclosure of which is hereby incorporated by reference in its entirety.

### FIELD OF THE INVENTION

The present invention relates generally to training software and, more specifically, to a training system which simulates an engine utilizing an electronic control system.

### SUMMARY OF THE INVENTION

Exemplary embodiments of the present invention provide an engine simulation system utilized for training purposes. In exemplary embodiments, the simulator is a trailer-mounted, self-powered mobile unit that contains a fully functioning control system (e.g., Adem3) used on the latest Caterpillar 35 and 36 series engines. A programmable logic controller and other related components simulate engine activities and operational sequences that interface with controls system. A trainer is able to “bug” the system physically, electronically or via programming, thus allowing applied on the job training during the course of instruction without any service interruption to real equipment.

### BRIEF DESCRIPTION OF THE DRAWINGS

FIG. 1 illustrates components of a training simulator system according to an exemplary embodiment of the present invention; and

FIG. 2 illustrates a methodology utilizing the training simulator system according to an exemplary methodology of the present invention.

### DESCRIPTION OF ILLUSTRATIVE EMBODIMENTS

Illustrative embodiments and related methodologies of the present invention are described below as they might be employed in a training simulator. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of the invention will become apparent from consideration of the following description and drawings.

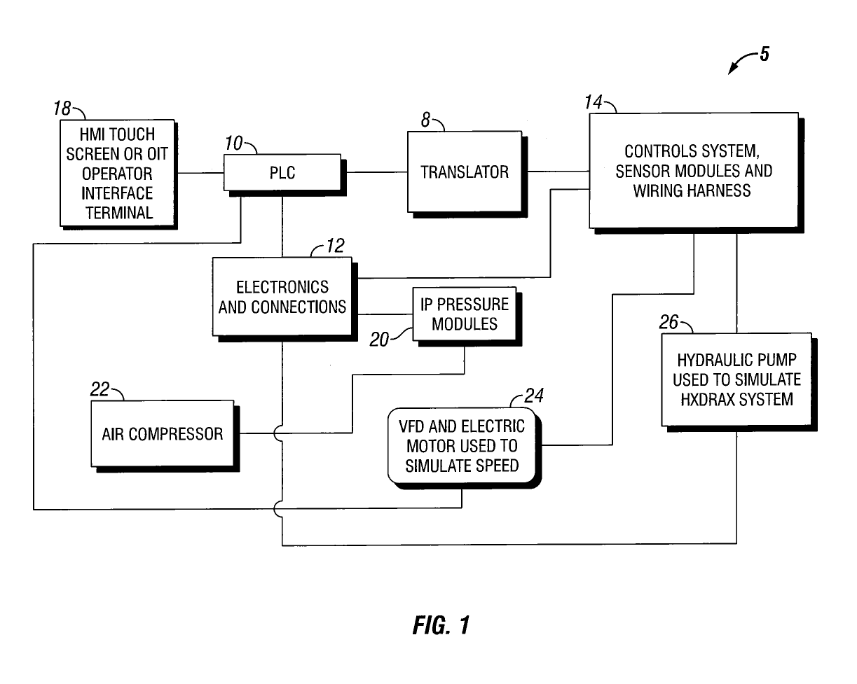

FIG. 1 illustrates a training simulator 5 according to an exemplary embodiment of the present invention. A programmable logic controller 10 and translator 8, along with electronics 12, simulates engine activities and operational sequences that interface with the control system 14. In this embodiment, control system 14 is a Caterpillars ADEM III electronic control system. However, those ordinarily skilled in the art having the benefit of this disclosure realize other control systems may be utilized. Moreover, logic controller 10 may comprise memory and a processor for implementing software embodying methods of the present invention, as would also be understood by one ordinarily skilled in the art having the benefit of this disclosure.

Simulated engine activities may include monitoring and adjusting of engine pressures, temperatures, air fuel ratios, cylinder burn times, and engine load. IP pressure modules 20, air compressor 22, variable frequency drive and motor 24, and hydraulic pump 26 are all utilized to simulate various engine “bugs.” Utilizing the present invention, a student is allowed to simulate and control various fault sensors, modules, and wiring harnesses, as well as the ability to load/unload the engine as desired.

Referring to FIG. 1, an exemplary layout of training simulator 5 is illustrated. A graphical user interface 18, such as a HMI touch screen, interfaces with the user. A programmable logic controller 10, which is used to implement the bugs, is coupled to interface 18. A translator 8, such as a Monico Inc. Gateway Plus translator, is coupled between controller 10 and control system 14. Control system 14 contains sensor modules and wiring harnesses in order to receive and process the fault codes received from other system components. The fault codes are viewed at the Caterpillar's machine information display system (“Cat MIDS”) panel or through the Caterpillar's electronic technicians (“Cat ET”) software, as would be understood by one ordinarily skilled in the art having the benefit of this disclosure.

A pump 26, used to simulate a hydrax system, and pressure module 20 are coupled to control system 14. Electronics 12 are also coupled to pressure modules 20 in order to simulate pressure fluctuations in control system 14. Drive and motor 24 is coupled to control system 14 and controller 10 in order to simulate various engine bugs and fluctuations. Also, an air compressor 22 is coupled to pressure module 20 in order to effect the pressure changes. Note that the present invention is not coupled to an actual engine. Rather, real sensors are modules are utilized to simulate an engine.

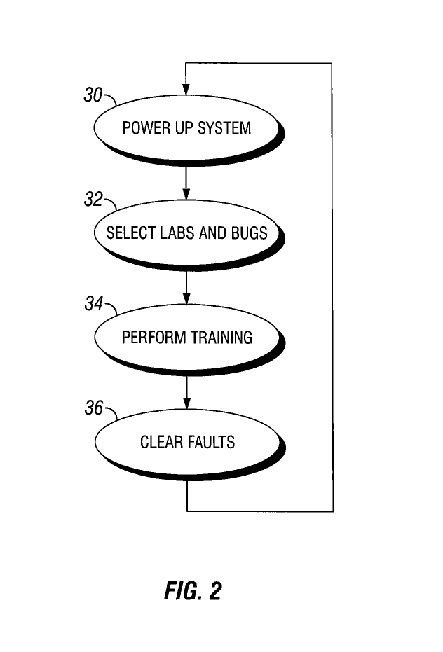

FIG. 2 illustrates a flow chart embodying an exemplary methodology of the present invention. At step 30, simulator 5 is powered up using a Master PLC Panel Power switch located adjacent to interface 18. Also, control system 14 is powered up by switching its CAT panel mode control switch (not shown) to AUTO. The CAT panel mode control switch is located on the Cat MIDS panel. At step 32, the user may select various labs and “bugs” via interface 18, and the training is initiated via interface 18. After the training has begun, the mode control switch is turned to START, and controller 10 will initiate and control the faults, or “bugs,” as selected. Thereafter, the user undergoes training via interface 18 at step 34. At step 36, the reset button is pressed on the CAT panel mode control switch, and the faults are cleared. The process may then be repeated.

Although there are a variety of labs and bugs that could be implemented using the present invention, some exemplary ones will now be discussed. The following are exemplary labs that test a user's knowledge of the engine steps which occur during the start-up sequence:
(1) CAT ET Lab for Data Logging and MIDS Navigation—this lab will test data logging showing the pressure and temperature changes;
(2) SWITCH AS-PRESSURE (PRELUBRICATION)—In order to perform this lab, do not turn on the pre-lube pressure solenoid via the controller 10. As a result, motor 24 will shut down due to a lack of pre-lube pressure and an error code will be displayed on interface 18. The solenoid on the MIDS will shown the pre-lube energized, but the pre lube pressure switch will not show a READY signal. Also, do not turn on the solenoids to the pre and post oil pressure sensors (located in pressure modules 20). Here, the pre-lube pressure solenoid would supply pressure to the sensor, thus communicating back to controller 10 there is oil pressure;
(3) SENSOR GP-PRESSURE (GAS)—Here, gas pressure is applied to motor 24 before the fuel valve is opened during the start-up. In return, controller 10 will shut down the system due to the pressure present during cranking;
(4) SWITCH AS-PRESSURE (PRELUBRICATION)—When motor 24 is attempting to start, turn on all three oil pressure solenoids via controller 10 and open the wires from the pre-lube pressure switch, which results in a sensor fault being returned to the controller 10;
(5) SWITCH AS-PRESSURE (Hydrax oil)—When the starter comes on, keep the Hydrax pressure switch open. Note the starter is not an actual starter; it is logic embedded in the Cat ET software that sends a signal to open a solenoid to engage a starter. As a result, motor 24 will crank but not start because the fuel valve will not come on. Note, however, this will not generate a code, motor 24 will just fail to start. The pulsing is done through logic programmed within control system 14. The logic is to allow starter to engage for a predetermined amount of time (typically 30 seconds) then rest for the same amount of predetermined time, then re-engage. This is called the crank cycle. There is also a Cat logic that is called Overcrank, whereas once this predetermined time is reached the starter will not re-engage and a fault is generated. Typically Overcrank is set at 300 seconds) Therefore, the “pulsing” is the re-engagement of the starter during the Crank Cycle and, once the Overcrank time has lapsed, a fault is generated. In turn, a failure to start code will be returned to controller 10.
(6) SWITCH AS-PRESSURE (Hydrax oil)—Here, a relay is utilized to swap from normal operation to a bug via controller 10. The bug will be to open the wiring circuit on the sensor side of control system 14 while motor 24 is running after 30 seconds have expired. In turn, a code will be returned showing a low hydrax pressure, which is interpreted as the hydrax pressure switch intermittingly failing.
(7) FUEL SHUTOFF VALVE—in this lab, do not allow motor 24 to start. Instead, pulse motor 24 for the speed timing wheel on and off keeping the RPM's low while the starter is on. Motor 24 will fail to start. In turn, a failure to start code will be returned to controller 10. The trouble shooting process will be to check the resistance on the fuel valve, which is connected to the wiring harness of control system 14. The relay contacts will be open so the coil will show to be bad.
(8) OVERLOAD—In this lab, the air inlet restriction switch is tripped after motor 24 has been normally running for a few minutes. An alarm will trip as a result and motor 24 will overload (and controller 10 will show an overload code). Here, the alarm may be various codes such as shutdown codes.
(9) CYLINDER—In this lab, a dead cylinder code will be returned to controller 10. The cylinder temperature is dropped, while the burn times are raised. Here, controller 10 transmits a reduced resistance value to control system 14. As a result, motor 24 will overload.
(10) SENSOR GP-TEMPERATURE (FUEL, WATER, COOLANT)—In this lab, sensors in control system 14 are shorted to ground. Thus, controller 10 outputs a VDC signal lower than 1.4 VDC which results in a fault code being generated by control system 14. Sensor Supply Voltage is 0-5 VDC.
(11) SENSOR SUPPLY VOLTAGE (CRANKCASE, FILTERED OIL)—In this lab, sensors in control system 14 are shorted to ground utilizing a PWM type circuit.
(12) SENSOR GP-TEMPERATURE (OIL, MANIFOLD AIR)—In this lab, signal wiring for the harness in control system 14 are shorted to battery positive or open). Sensor voltage is 0-5 Volts, and results in an intermitting fault.
(13) SENSOR GP-PRESSURE (UNFILTERED OIL, AIR MANIFOLD PRESSURE)—In this lab, signal wiring for the sensor fault is shorted to ground utilizing a PWM type circuit.

Next, further referring to the exemplary embodiment of FIG. 1, the simulation of thermocouple temperatures will now be described. Programmable logic controller 10 comprises 0-20 MA analog cards (which are embodied in electronics 12). A 250 OHM resistor is coupled to the analog cards in order to turn the signal into 0-5 VDC. As understood by those ordinarily skilled in the art having the benefit of this disclosure, a voltage divider is utilized to reduce the voltage down to the required MA voltage in order to simulate a K-type thermocouple. Programmable logic controller 10 then uses a scale of parameters to output the required temperature at the correct time, as understood in the art.

An exemplary simulation of the analog sensor, mounted on system 5, will now be described. 0-20 MA analog cards are utilized within programmable logic controller 10, where a 250 OHM resistor is coupled to turn the signal into 0-5 VDC. Controller 10 then utilizes a scale of parameters to output the required voltage at the correct time, as understood in the art.

An exemplary simulation of the PWM sensor will now be described. Utilizing pressure modules 20, IP transmitters simulate the pressures to the end devices via the analog output cards of controller 10. Programmable logic controller 10 then utilizes scale of parameters to output the required current ant the correct time to the IP transmitters located in modules 20.

An exemplary simulation of the sensor faults will now be described. A variety of sensors are located in control system 14, as would be understood by one ordinarily skilled in the art having the benefit of this disclosure. All sensor and harness wiring is ran from the sensor or harness to terminal blocks in the simulator panel (which is located on the simulator). The terminal blocks (not shown) are set up to come from the sensor or harness and back to the sensor or harness. Depending on what wires are utilized for the pre-defined faults, will determine if the terminal is jumped back to the sensor or ran threw a relay to fault out the system 5. For the simulated analog signals, do not use the sensor but, instead, send back a signal voltage as required to simulate the sensor or end device via the programmable logic controller 10. All end devices that have a coil are ran to the contacts of a relay in order to simulate a true coil. Here, controller 10 transmits a signal (typically control ground) to energize the relay coil which, in turn, closes a set of contacts to send or remove the signal to turn on a device, such as the fuel valve.

An exemplary simulation of the speed timing system will now be described. Motor 24 is used to simulate the speed timing wheel via a 110 VAC motor with a variable frequency drive. Utilizing a Monico Inc. CDL Gateway communications device, programmable logic controller 10 is allowed to view all the CAT data, as understood in the art. Based on the CAT desired speed set point, the speed of the AC motor is varied via the variable frequency drive and a 4-20 MA signal via the logic in controller 10. In addition, all pressure switches on the panel of control system 10 are simulated via pressure solenoids turned on and off utilizing controller 10.

Referring back to FIG. 1, exemplary connections for control system 14 will now be described. Note, however, one ordinarily skilled in the art having the benefit of this disclosure would realize there are a variety of connections and means in which to implement the present invention. The following is simply a high-level overview of an exemplary embodiment. J5 connectors, used as the front and back main engine harnesses, may be utilized to simulate harness bug faults. All break out wires are 25 feet long and there are a total of 36 pairs of wires. A harness of 46 wires may also be utilized in order to provide spares. A J2 connector, having 24 wires, may be utilized for ignition wiring. A separate junction box may be mounted to simulator 5 to terminate each wire in the harness for student visualization and troubleshooting. The engine harness of control system 14 connects via connectors to the bottom of the junction box and there is a short jumper harness which connects to control system 14. There is also a terminal point for each wire between the engine harness and the short jumper harness.

Control system 14 also comprises a plurality of sensors and switches that simulate an engine. The sensors and switches are coupled to programmable logic controller 10, whereby the user is allowed to bug, control, or diagnose various engine characteristics via interface 18. Controller 10 also comprises a plurality of relay outputs. Exemplary switches may include:
(1) SENSOR GP-PRESSURE (CRANKCASE)—when activated as a bug, a solenoid and regulator control pressure at 0.5 psi;
(2) SWITCH AS-PRESSURE (JACKET WATER INLET)—a solenoid and regulator control pressure at 30 psi when activated. During normal operation, each is switched off;
(3) SWITCH AS-PRESSURE (PRELUBRICATION)—when activated, a solenoid and regulator control pressure at 15 psi. After pre-lube is energized, each is energized for 10 sections and remains on until the fuel valve is activated;
(4) SENSOR GP-PRESSURE (FILTERED OIL)—a solenoid and regulator controls pressure at 60 psi. After pre-lube is energized, each is energized for 10 seconds, and remains on until the fuel valve is activated; and
(5) SENSOR GP-PRESSURE (UNFILTERED OIL)—a solenoid and regulator controls pressure at 58 psi. After pre-lube is energized, each is energized for 10 seconds, and remains on until the fuel valve is activated.

Exemplary relays may include:
(1) HYDRAX PUMP—A relay is used to close the pump after the engine starter activates for 2 seconds;
(2) ENGINE START RELAY—when the engine needs to start, this relay is grounded;
(3) DRIVEN EQUIPMENT OK RELAY—When driven equipment is ready to start, this relay is grounded;
(4) ELECTRIC MOTOR SPEED FOR ENGINE SPEED SENSOR—A relay is utilized to stop and run the motor 24 for the speed sensor frequency drive;
(5) SWITCH AS-PRESSURE (PRELUBRICATION)—while the engine is attempting to start, activate all three oil pressure solenoids, but open the wires from the pre-lube pressure switch (Sensor fault). The engine will shutdown on pre-lube pressure switch failure;
(6) SWITCH AS-PRESSURE (HYDRAX OIL)—When the starter comes on, the Hydrax pressure switch remains open. The engine will crank, but not start because the fuel valve will not activate. However, this will not generate a code. The engine will simply fail to start; and
(7) AIR INLET RESTRICTION—Trip the air inlet restriction switch after the engine has been normally running for a few minutes. The will provide an alarm only at first. The engine will have been running at 100% load. Once tripped, the engine RPM will fall off and the engine will overload.

Exemplary relay inputs into programmable logic controller 10, and from the control system panel (not shown), may include a VALVE GP-SOLENOID representing the starter, pre-lube, or fuel valve solenoids. Relays can be utilized so the controller 10 will detect when the starter is running.

As described in exemplary embodiments herein, simulator 5 is a trailer-mounted, self-powered mobile unit that contains a fully functioning control system (e.g., Adem3) used on the latest Caterpillar 35 and 36 series engines. Programmable logic controller 10, along with electronics 12, simulate engine activities and operational sequences that interface with controls system 14. A trainer is able to “bug” the system physically, electronically or via programming, thus allowing applied on the job training during the course of instruction without any service interruption to real equipment.

An exemplary embodiment of the present invention provides an engine training simulator system comprising a user interface; a programmable logic controller coupled to the user interface, the programmable logic controller being utilized to implement various system faults; a translator coupled to the programmable logic controller; and a control system coupled to the translator, the control system being adapted to receive and process system fault codes, wherein the training simulator system simulates engine activities and operational sequences that interact with the control system. Another embodiment comprises a pump and pressure modules coupled to the control system. Yet another comprises a drive and motor coupled to the control system.

In another exemplary embodiment, the programmable logic controller comprises a plurality of connections coupled directly to the translator, pressure modules, pump, and control system. In yet another, the simulated engine activities comprise at least one of a monitoring and adjusting of engine pressures, temperatures, air fuel ratios, cylinder burn times or engine load. In another, the control system further comprises an information display system panel to display the system fault codes. In yet another, the system is a trailer-mounted, self-powered mobile unit.

An exemplary methodology of the present invention provides a method using an engine training simulator system, the method comprising the steps of (a) selecting a system fault via a user interface; (b) implementing the system fault wherein at least one engine scenario is simulated; (c) detecting the system fault at a control system of the simulator system; and (d) communicating the detected fault to the user interface. In another, step (a) further comprises the step of selecting from a list of system faults comprising an engine pressure or temperature, air fuel ratio, cylinder burn time, or engine load. In yet another, step (b) further comprises the step of implementing the system fault in at least one of a pressure module, pump or motor. In another, step (d) further comprises the step of communicating the detected fault to a display system panel.

Another exemplary embodiment of the present invention provides a computer readable medium that stores therein a computer program for implementing an engine training simulator system, the computer program causing a computer to execute the steps of: (a) displaying at least one system fault on a display; (b) detecting a selection of the at least one system fault; (c) implementing the system fault wherein at least one engine scenario is simulated; (d) detecting the system fault at a control system of the simulator system; and (e) communicating the detected fault to the display. In another, step (a) further comprises the step of displaying at least one of an engine pressure or temperature, air fuel ratio, cylinder burn time, or engine load fault. In yet another, step (b) further comprises the step of implementing the system fault in at least one of a pressure module, pump or motor. In yet another, step (d) further comprises the step of communicating the detected fault to a display system panel.

Although various embodiments and methodologies have been shown and described, the invention is not limited to such embodiments and methodologies and will be understood to include all modifications and variations as would be apparent to one skilled in the art. Therefore, it should be understood that the invention is not intended to be limited to the particular forms disclosed. Rather, the intention is to cover all modifications, equivalents and alternatives falling within the spirit and scope of the invention as defined by the appended claims.

I claim:

1. An engine training simulator system comprising:
a user interface;
a programmable logic controller coupled to the user interface, the programmable logic controller being utilized to implement various system faults;
a translator coupled to the programmable logic controller; and
a control system coupled to the translator, the control system being adapted to receive and process system fault codes,
wherein the training simulator system simulates engine activities and operational sequences that interact with the control system.

2. A system as defined in claim 1, further comprising a pump and pressure modules coupled to the control system.

3. A system as defined in claim 2, further comprising a drive and motor coupled to the control system.

4. A system as defined in claim 3, wherein the programmable logic controller comprises a plurality of connections coupled directly to the translator, pressure modules, pump, and control system.

5. A system as defined in claim 1, wherein the simulated engine activities comprise at least one of a monitoring and adjusting of engine pressures, temperatures, air fuel ratios, cylinder burn times or engine load.

6. A system as defined in claim 1, wherein the control system further comprises an information display system panel to display the system fault codes.

7. A system as defined in claim 1, wherein the system is a trailer-mounted, self-powered mobile unit.

8. A method using an engine training simulator system, the method comprising the steps of:
(a) selecting a system fault via a user interface;
(b) implementing the system fault wherein at least one engine scenario is simulated;
(c) detecting the system fault at a control system of the simulator system; and
(d) communicating the detected fault to the user interface.

9. A method as defined in claim 8, wherein step (a) further comprises the step of selecting from a list of system faults comprising an engine pressure or temperature, air fuel ratio, cylinder burn time, or engine load.

10. A method as defined in claim 8, wherein step (b) further comprises the step of implementing the system fault in at least one of a pressure module, pump or motor.

11. A method as defined in claim 8, wherein step (d) further comprises the step of communicating the detected fault to a display system panel.

12. A computer readable medium that stores therein a computer program for implementing an engine training simulator system, the computer program causing a computer to execute the steps of:
(a) displaying at least one system fault on a display;
(b) detecting a selection of the at least one system fault;
(c) implementing the system fault wherein at least one engine scenario is simulated;
(d) detecting the system fault at a control system of the simulator system; and
(e) communicating the detected fault to the display.

13. A computer readable medium as defined in claim 12, wherein step (a) further comprises the step of displaying at least one of an engine pressure or temperature, air fuel ratio, cylinder burn time, or engine load fault.

14. A computer readable medium as defined in claim 12, wherein step (b) further comprises the step of implementing the system fault in at least one of a pressure module, pump or motor.

15. A computer readable medium as defined in claim 12, wherein step (d) further comprises the step of communicating the detected fault to a display system panel.
